(19) United States
(12) Patent Application Publication
(10) Pub. No.: US 2010/0286910 A1
(43) Pub. Date: Nov. 11, 2010

(54) Illuminated Safety Net

(76) Inventor: Jack F. Hudson, Tequesta, FL (US)

Correspondence Address: MCHALE & SLAVIN, P.A., 2855 PGA BLVD, PALM BEACH GARDENS, FL, 33410, US

(21) Appl. No.: 12/771,388

(22) Filed: Apr. 30, 2010

Related U.S. Application Data
(60) Provisional application No. 61/174,750, filed on May 1, 2009.

(51) Int. Cl. F21L 4/02; F21S 4/00; F21V 1/00; G01C 21/00

(52) U.S. Cl. 701/213; 362/249.15; 362/184; 362/235

(57) ABSTRACT

An illuminated safety net having a matrix arrangement of woven flexible material including an array of intersecting rows and columns that define a plurality of open spaces and an outer edge thereabout having a mounting means for attachment to a surface; a plurality of electrical leads interlaced within the rows or columns of the matrix of the net; a plurality of light sources coupled to the plurality of electrical leads and positioned at the intersection of the rows and columns; and a battery pack coupled to the electrical leads providing a power source to the plurality of lights. The illuminated safety net serves as a rescue marker or warning means to others. The illuminated safety net is compact enough to be stored in a rolled-up fashion and be conveniently stowed away in confined areas. The illuminated safety net may use auxiliary light sources not requiring a power source attached thereabout the net as a secondary means to illuminate.

### CROSS REFERENCE TO RELATED APPLICATIONS

The present application claims the benefit of priority under 35 U.S.C. §119(e) to U.S. Provisional Patent Application No. 61/174,750, filed May 1, 2009, entitled, “Illuminated Safety Net”, the contents of which are incorporated herein by reference.

### FIELD OF THE INVENTION

This invention relates generally to a net and, more particularly, to a safety net having a plurality of light sources attached thereto and throughout, thus serving as a rescue marker or warning means.

### BACKGROUND OF THE INVENTION

When there are vehicle breakdowns, collisions, or repairs on the highways or roads, a variety of devices have been used to warn other vehicles of the approaching hazard. Emergency warning devices, such as flashlights, reflectors, flares, and cones, are well known, but they can consequently cause more serious hazards than are present. For instance, flares can exacerbate a problem if gas fumes, oil, chemicals, or other combustible materials are present. In other instances, the emergency warning device can prove to be unreliable in a time where reliability is crucial. For instance, flashlights are not reliable sources of rescue markers and warning means as they are typically left in vehicles for long periods of time with the batteries disposed within, and when called upon to emit light the batteries are no longer functional and render the flashlight inoperable. Other emergency warning devices can just be inconvenient, cumbersome, or inadequate for performing their intended functions. Cones, although adequate to serve as a rescue or warning marker, are extremely cumbersome and take up too much space when stowed in the trunk of a vehicle, and thus the owner may choose to not clutter the trunk space with bulky cones. Even if the cones were to be sold in smaller sizes, their effect in notifying other vehicles of an oncoming hazard would be futile because it may be out of sight to an approaching vehicle.

If an emergency were to occur in the woods, it is recommended that campers create a signal visible from the air (smoke signals), lay out brightly colored clothing in a clearing, use a signal mirror, use air horns, or dye markers. However, in the woods, the use of smoke signals may create potentially dangerous situations. It is recommended that smoke signals be created using damp foliage; however, if conditions are dry in the woods a small spark can potentially create a large scale wilderness fire. Furthermore, the use of brightly colored clothing is not preferred in the wilderness because it is not visible at night and it does not reflect the heat effectively, as a camper would be interested in maintaining a low body heat throughout the day. Air horns, although adequate in creating audible signals, are limited to short distances and could potentially arouse the interest of a curious bear because the sound emitted may sound like an elk or a moose. Although the emergency devices described are adequate means to create a signal for emergency purposes or to alert the presence thereof, they have their associated disadvantages.

In an attempt to alleviate some of the aggravation experienced by vehicle owners, U.S. Pat. No. 6,969,185 issued to Adair, disclosed a safety net that includes at least one illuminating strand, typically contained in a side-illuminating fiber optic pipe or conduit containing a plurality of light emitting diode (LED) illuminators to provide a means for alerting of road hazards and serve as a rescue marker. The safety net provides a safety and warning device to others and physically restraints entry into the hazardous area. However, the fiber optic pipe or flexible conduit containing a plurality of LED's is expensive to manufacture and thus raises the cost of the safety net device. Additionally, the fiber optic pipe or conduit is difficult to maneuver because of its rigidity; making the fiber optic pipe or conduit difficult to manipulate through the safety net, and if kinked the fiber optic pipe or conduit becomes opaque and does not allow the passage of light therethrough. As such, the device is expensive to manufacture and may not provide a reliable illuminating means for alerting others of the hazard ahead.

Thus what is needed in the art is a device that can to be used as an emergency rescue marker in the wilderness, at sea, and on the highways or roads. The illuminated safety net should be capable of visibly warning and alerting others of the presence thereof or of an approaching hazard. The illuminated safety net device should be easily packed in a rolled-up fashion, conveniently stowed in a vehicle trunk, backpack, or the like, and should be inexpensive to manufacture.

### SUMMARY OF THE INVENTION

The instant invention provides an illuminated safety net device formed of a woven or braided net constructed of flexible material having a matrix arrangement including an array of intersecting rows and columns that define a plurality of open spaces and an outer edge thereabout having a mounting means for attachment to a surface; a plurality of electrical leads interlaced within the rows or columns in the matrix arrangement of the woven net; a plurality of light sources coupled to the plurality of electrical leads and positioned at the intersection of the rows and columns on the matrix arrangement of the woven net; and a battery pack coupled to the electrical leads providing a power source to the plurality of lights. When illuminated, the safety net serves as a rescue marker or warning means to others. The illuminated safety net is compact enough to be stored in a rolled-up fashion, and be conveniently stowed away in confined areas. The illuminated safety net may use auxiliary light sources not requiring a power source, such as reflectors, attached thereabout the woven net as a secondary means to illuminate. The mounting means about the outer edge of the woven net may include bungee cords, suction cups, grommets, standing posts, weights, inflatable tubes, or the like for attachment to a variety of surfaces.

Accordingly, it is an objective of the present invention to provide an illuminated safety net device to be used as an emergency rescue marker in the wilderness, at sea, and on the highways and roads. The illuminated safety net device may also serve as a road hazard alert, a restraint toward entry, or a notification of presence thereof.

It is another objective of the present invention to provide an illuminated safety net device which includes a controller for switching between spectrums of colors. The controller will allow a user to vary the light color from a white light, typically used for illuminating purposes, to a red light, which serves as an emergency alert to others.

It is yet another objective of the present invention to provide an illuminated safety net device having a variety of mounting means for attachment to a surface. The contemplated mounting means include bungee cords, suction cups, grommets, standing posts, weights, inflatable tube, or the like. The mounting means are connected to the outer edge of the safety net for securely attaching to a surface.

It is still yet another objective of the present invention to provide an illuminated safety net device that provides a secondary means of illumination not requiring a power source for emergency situations where a power source is not available. The secondary means of illumination comprises of an auxiliary light source, such as a reflector, attached to the net.

It is a further objective of the present invention to provide an illuminated safety net device which at night becomes even more visible when illuminated to alert others as to the presence thereof.

It is a further objective of the present invention to provide an illuminated safety net device which is capable of being rolled up so as to be conveniently stowed away in confined areas, such as a trunk of a vehicle or backpack. The illuminated safety net device would be available in a variety of sizes and configurations, constructed to be durable, lightweight, inexpensive to manufacture, and easily transportable.

It is yet a further objective of the present invention to provide an illuminated safety net device having open spaces defined by the array of intersecting rows and columns on the matrix arrangement that allows wind to blow freely therethrough so as not to cause the illuminated safety net to sway or be knocked over by strong winds.

It is yet another objective of the present invention to provide an illuminated safety net device, which in marine applications provides an auxiliary signal for use as a rescue and warning marker that is conveniently stowed, easily installed, and adequately alerts. Although the Coast Guard only requires three signals, safety experts recommend that boaters carry an assortment of handheld and aerial signals.

It is also a further objective of the present invention to provide an illuminated safety net device, which in highway and roadside applications warns oncoming motorists to steer clear of the roadside hazard and can help alert emergency vehicles of the ongoing emergency. Every year, motorists are left stranded because of highway or roadside emergencies, and are unnecessarily killed or injured by oncoming traffic because of the limited visibility.

It is also a further objective of the present invention to provide an illuminated safety net device, which is capable of floating by inflating an inflatable tube on the outer edge of the woven net to serve as a rescue marker or warning means.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top view of the illuminated safety net device of the present invention;

FIG. 2 is a pictorial representation of the illuminated safety net device in use;

FIG. 3 is an end view of the illuminated safety net device in a rolled-up fashion;

FIG. 4 is an enlarged view of the matrix arrangement, electrical leads, and light source on the illuminated safety net device of the present invention; and

FIG. 5 is a perspective view of an alternative embodiment of the illuminated safety net device of the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

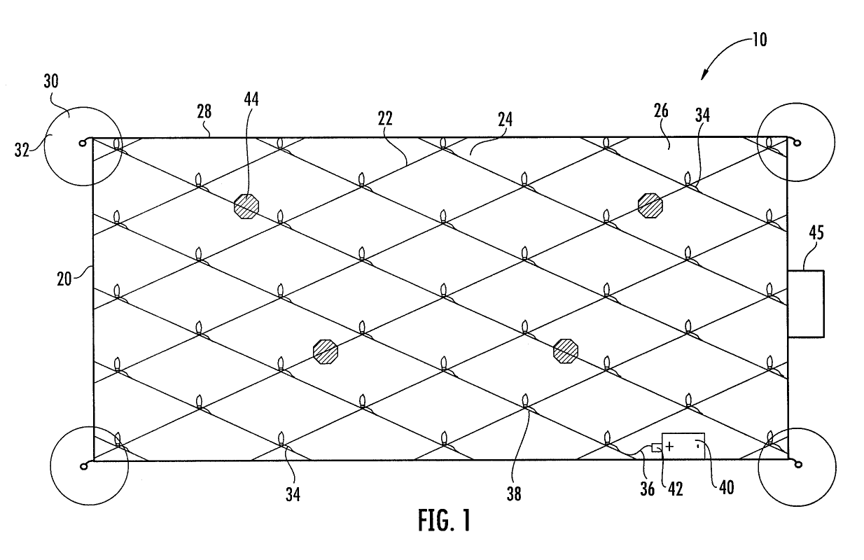

Referring now to FIGS. 1-4, an illuminated safety net device 10 is illustrated. The illuminated safety net device 10 includes a net 20, plurality of light sources 38, plurality of electrical leads 34, a power source 40, and an auxiliary illuminating means 44, as shown in FIG. 1. The net 20 has a matrix arrangement constructed of flexible material, typically of an array of intersecting rows 22 and columns 24 that define a plurality of open spaces 26. Although shown as a rectangular net 20, the net may be constructed in any geometrical shape. The rows 22 and columns 24 are comprised of flexible material that extends the length and width of the net 20. At the intersection of the rows 22 and columns 24, the strands of flexible material may be woven, braided, tied, interlaced, glued, or the like. The strands of flexible material may be of any thickness suitable for the intended use of the present invention. The flexible material includes polymeric material, natural or synthetic fibers, fabric, or any other lightweight and durable material which may be used in the construction of the net. The net 20 includes an outer edge 28 thereabout the periphery of the rectangular array which encloses the matrix arrangement and forms one continuous outer edge 28 strand about the periphery. The open spaces 26 may be of any geometrical shape; as shown, the open spaces 26 are rectilinear. Wind is capable of passing through the open spaces 26 of the net.

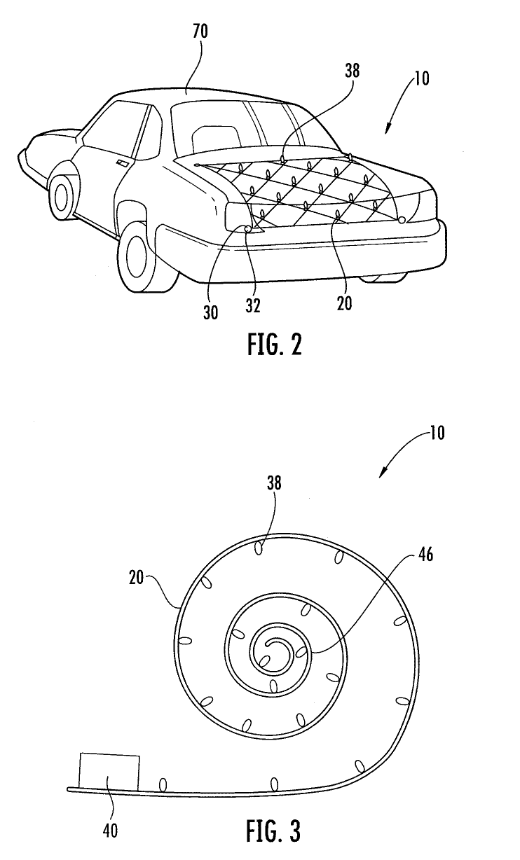

As shown in FIGS. 1 and 2, the net 20 includes a mounting means 30 for attachment to a surface, such as a vehicle 70 (as shown in FIG. 2), tree, campsite, boat, boat mast, or the like. The mounting means 30 is attached to the outer edge 28 of the net 20. Various mounting means 30 are contemplated for securing the net 20 to a surface, such as suction cups 32, bungee cords, grommets, standing posts, weights, or the like. FIG. 1 shows suction cups 32 on the outer edge 28 of the net 20, and FIG. 2 shows the suction cups 32 in use as they are attached to the exterior of a vehicle 70 to provide a secure attachment. Suction cups 32 are contemplated for use with smaller nets. Grommets are contemplated for use in the larger nets, not shown. The grommets are preferably connected to the outer edge 28 of the net 20, whereby an eyelet on the grommet permits the attachment of the strands on the outer edge 28 of the net 20 (not shown). Bungee cords are preferably connected at the corners of the outer edges 28 for attachment to a surface, such as a tree, post or the like, not shown.

The size of the net 20 will vary depending on different applications. By way of example, the net for automotive applications may have dimensions of approximately 1½′×4′, the net for camping or boating applications may have dimensions significantly larger of approximately 4′×6′. These examples are not to be considered to limit the net to these dimensions. Many other dimensions and shapes of the net are possible. Regardless, the illuminated safety net device 10 can be stored in a rolled-up fashion 46 and be conveniently stowed away in confined areas, as shown in FIG. 3.

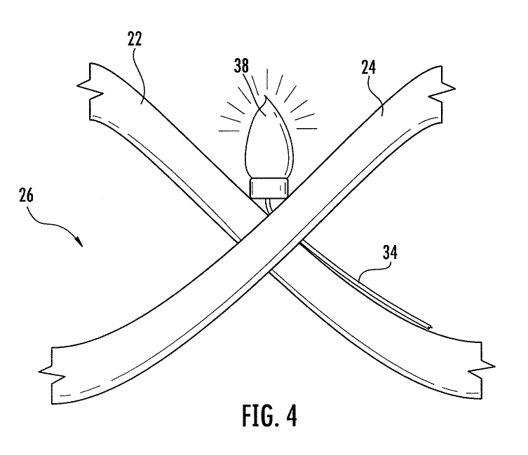

As shown in FIGS. 1 and 4, each electrical lead 34 is interlaced within the rows 22 or columns 24 strands of the woven net 20. The electrical leads 34 may run alongside a row 22 or a column 24, or the lead 34 may intersect through the open spaces 26. Each electrical lead 34 is connected in a bundle 36 to a power source 40 on one end and on the opposite end to a light source 38. Preferably, each electrical lead 34 terminates at the intersection of a row 22 and a column 24. At the intersection, the electrical lead 34 is coupled to a light source 38. The light source 38 is preferably any low-wattage light emitting device, such as but not limited to a light emitting diode (LED). The power source 40 for use with the lit safety net device 10 is preferably a battery pack which is attached to the net 20 on the outer edge 28. Additional power sources 40 to illuminate the light sources 38 can be, but are not limited to, simple automotive electrical power adapters, solar panels, car batteries, inverters, or other electrical power generating means.

As shown in FIGS. 1 and 4, each light source 38 is coupled to an electrical lead 34 and positioned at the intersection of the rows 22 and columns 24 on the matrix arrangement of the woven net 20. However, it is contemplated that the leads 34 may also extend further from the intersection and into the open space 26 and the light source 38 would be coupled in the open space 26, not shown. The light sources 38 are preferably coupled to a control switch 42 which allows the light source 38 to emit a spectrum of colors. Each light source 38 may transition between spectrums of color controlled by the control switch 42. For instance, a multi-color LED; or each independent light source 38 may be of different spectrums to provide various color arrangements on the net 20. For example, the light sources 38 may emit a white light for ordinary purposes, but in emergency situations a red light would be emitted to alert others of an emergency. Furthermore, the controller 42 may selectively light different zones within the net 20 to provide a variety of patterns or symbols by selectively lighting certain light sources 38 within a zone.

Additionally, the illuminated safety net 10 may use auxiliary light sources 44, such as reflectors, not requiring a power source 40, and attached thereabout the woven net 20 as a secondary means to illuminate, shown in FIG. 1. This auxiliary light source 44 is particularly useful in the instance where the power source 40 is either not available or may no longer be operable. The reflectors may be already attached to the net 20 at various places thereon, or they may come separately and include clips or other attachment means, not shown, to securely attach to the net 20.

As shown in FIG. 2, when illuminated, the safety net 10 serves as a rescue marker or warning means to others. When the user is ready to deploy the illuminated safety net 10, the rolled-up net 46 is removed from the trunk, backpack, or elsewhere and clamped to the bumper, suctioned to the window, latched to the rear of the vehicle, draped across a vehicle, hung on a tree, laid out in an open space, inflated, or other uses. The user unrolls the lit safety net 10 across the area desired and then connects the power source 40 to the safety net 10.

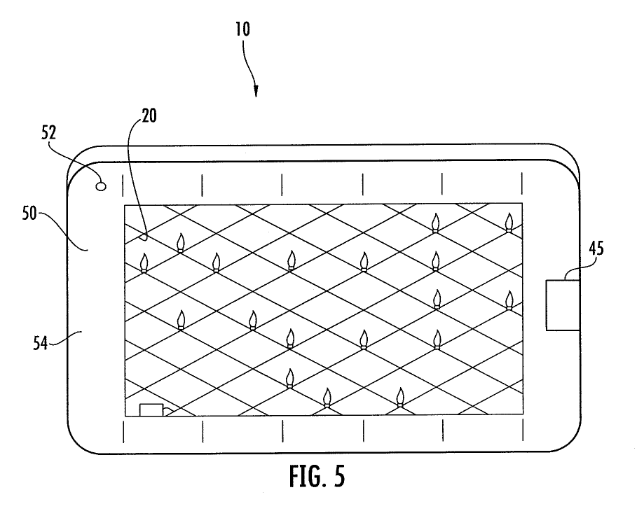

As shown in FIG. 5, the illuminated safety net 10 may employ the use of an inflatable tube 50 about the outer edge 28 thereof. The inflatable tube 50 attaches to the net 20 on the outer edge 28 and extends along the periphery. The inflatable tube 50 may be inflated manually or by carbon dioxide cartridge to serve as a floatation device or as a propping structure. The inflatable tube 50 comprises of a continuous bladder, made of an elastomer, in the shape of a cylinder. The inflatable tube 50 inflates and dis-inflates manually through an aperture 52 on the exterior surface 54 of the tube 50. The aperture 52 may be opened to inflate or dis-inflate and closed to seal the inflatable tube 50. The inflatable tube 50 is preferably constructed of an elastomer; however, other suitable materials are contemplated.

A communication device can optionally be included with the illuminate safety net. The communication device will enable an individual to contact emergency services or other services which the individual may require. For example, if the illuminated safety net 10 is used on an automobile, as illustrated in FIG. 2, when an individual's vehicle is disabled the communication device 45 can be used to contact emergency services or other types of services. The communication device can function like an OnStar® device currently employed in General Motor vehicles. The communication device can be automatically activated whenever the illuminated net 10 is deployed. Alternatively, the communication device 45 can be manually actuated by an individual. The communication device 45 is preferably a cellular phone and a GPS device. This combination enables an individual receiving a call from the individual in distress to determine the location of the individual should the individual not know their current location. The communication device 45 can also be utilized with the embodiment illustrated in FIG. 5. When the communication device 45 is used with this embodiment, it is preferably secured to the inflatable tube 50. The communication device 45 is especially useful whenever the embodiment of FIG. 5 is used on the open water where it is difficult for an individual to determine their position or location. When used on the open water the communication device can be used to call the coast guard or other service responsible for water safety on specific bodies of water.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An illuminated safety net device comprising:
a net having a matrix arrangement of flexible material including an array of intersecting rows and columns defining a plurality of open spaces;
at least one electrical lead interlaced within said net and coupled to a power source; and
at least one light source coupled to said at least one electrical lead.

2. The illuminated safety net device of claim 1, wherein said flexible material is woven.

3. The illuminated safety net device of claim 1, wherein said illuminated safety net device is compact enough to be stored in a rolled-up fashion.

4. The illuminated safety net device of claim 1, wherein said net includes an outer edge thereabout.

5. The illuminated safety net device of claim 4, wherein said outer edge includes a mounting means for attachment to a surface.

6. The illuminated safety net device of claim 1, wherein said at least one electrical lead is interlaced within said row or said column in said matrix arrangement of said net.

7. The illuminated safety net device of claim 6, wherein said at least one light source is positioned at said intersection of said rows and columns.

8. The illuminated safety net device of claim 6, wherein said at least one light source is positioned within said open spaces.

9. The illuminated safety net device of claim 1, wherein said at least one light source includes a plurality of light sources.

10. The illuminated safety net device of claim 9, wherein said at least one electrical lead includes a plurality of electrical leads.

11. The illuminated safety net device of claim 1, wherein said power source is a battery pack.

12. The illuminated safety net device of claim 11, wherein said battery pack is attached to said net.

13. The illuminated safety net device of claim 1, wherein said net includes at least one auxiliary light source attached thereto.

14. The illuminated safety net device of claim 13, wherein said at least one auxiliary light source is a reflector.

15. The illuminated safety net device of claim 4, wherein said outer edge includes an inflatable tube.

16. The illuminated safety net device of claim 15, wherein said inflatable tube comprises of a continuous bladder in the shape of a cylinder.

17. The illuminated safety net device of claim 16, wherein said inflatable tube includes a sealable aperture thereon.

18. The illuminated safety net of claim 1 wherein said net includes a communication device, said communication device includes a global positioning system device which enables an individual determine their current location.
